(19) United States
(12) Patent Application Publication
(10) Pub. No.: US 2009/0203302 A1
(43) Pub. Date: Aug. 13, 2009

(54) METHOD FOR THE SANITARY SLAUGHTER OF AN ANIMAL, AND A BAG FOR USE WITH THE SAID METHOD

(76) Inventor: Harm Kiezebrink, Epe (NL)

Correspondence Address: SHEWCHUK IP SERVICES, 3356 SHERMAN CT. STE. 102, EAGAN, MN, 55121, US

(21) Appl. No.: 12/063,660

(22) PCT Filed: Aug. 11, 2006
(86) PCT No.: PCT/NL2006/000420

§ 371 Date: Jun. 4, 2008

(30) Foreign Application Priority Data
Aug. 12, 2005 (NL) 1029721
Nov. 9, 2005 (NL) 1030379

(51) Int. Cl. A22B 3/08

(52) U.S. Cl. 452/66

(57) ABSTRACT

The present invention relates to a method for the sanitary slaughter of animals. The invention is especially suitable for the sanitary slaughter of poultry such as chickens, ducks and the like, in case of a break out of a contagious disease. The invention is characterized in that at least one body part selected from the nose and the mouth of the animal is covered with a foam prepared from a liquid and a gas, wherein the liquid contains a surfactant, and the gas used for making the foam comprises a gas component having the property to kill and/or narcotize the animal. A suitable gas component is for example carbon dioxide. The invention also relates to a bag (2) suitable for performing the procedure.

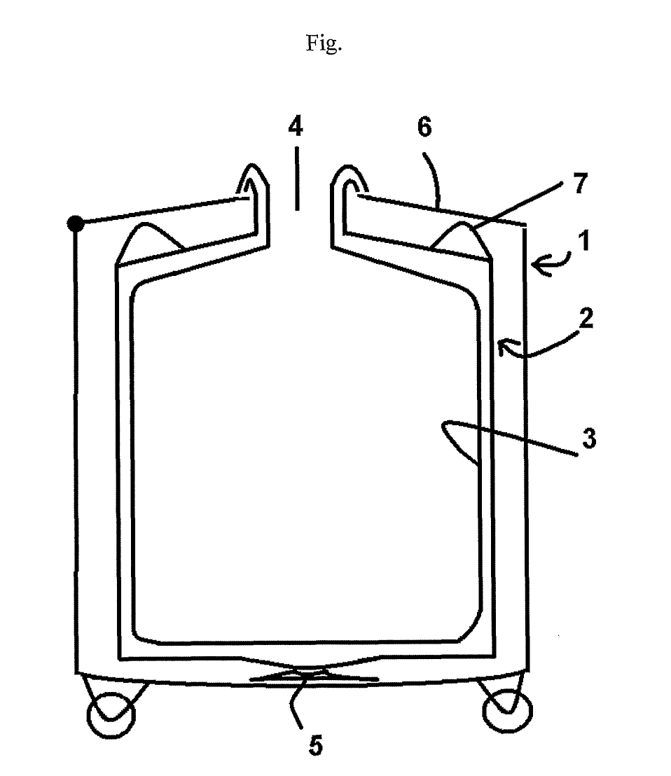

The present invention relates to a method for the sanitary slaughter of an animal.

In certain circumstances it is necessary to sanitarily slaughter animals, such as poultry and pigs, for example in order to prevent the spreading of a contagious disease such as fowl pest, New Castle-disease, foot and mouth disease etc. The contagious disease can be of a viral or bacterial nature. Especially in the case of viral diseases treatment is often impossible and the animals have to be destroyed. For a variety of reasons, it is desirable that this sanitary slaughter takes place as fast as possible, amongst others for reasons of animal welfare, to prevent further contamination and from the perspective of costs.

It is known to kill animals using a gas such as argon, carbon dioxide or carbon monoxide. According to a first possibility this is done by filling the space, in which the animals which are to be sanitarily slaughtered are kept, with the gas. This is expensive, time-consuming and leads to the use of more gas than is desirable. In the case of argon this leads to markedly increased costs, and in the case of carbon monoxide this leads to an increased risk, since even in low concentrations this gas is also lethal to humans. In order to address these problems it is known to bring the animals in a sealed container, which is subsequently filled with gas to kill the animals. After the animals have been killed, they are removed from the container after which the cycle is repeated.

From a perspective of costs, animal welfare and efficiency, the known methods leave room for improvement.

The object of the present invention is to provide a method according to the preamble which makes it possible to sanitarily slaughter animals faster while using less manpower and with reduced danger for the public health and to the personnel who carry out the sanitary slaughter.

To this end, the method according to the invention is characterised in that at least one body part selected from the nose and the mouth of the animal is covered with a foam prepared from a liquid and a gas, wherein the liquid contains a surfactant, and the gas used for making the foam comprises a gas component having the property to kill and/or narcotize the animal.

Although a foam bubble has a very thin liquid membrane, it appears to constitute a barrier that is sufficient for retaining a killing gas. Not only this aspect, but also the fact that the foam is visible and that it is thus evident where the highest concentrations of killing and/or narcotizing gas are located, increases the safety of the personnel who carry out the sanitary slaughter. If desired, the atmosphere above the foam can be ventilated in order to prevent the workers from being exposed to elevated concentrations of the killing and/or narcotizing gas. When the occasion arises, the method effectively restricts the spreading of pathogens such as an infectious virus, since the number of persons necessary for carrying out the sanitary slaughter is limited, and contaminated animals are shielded from the environment effectively. The foam adheres to the animal and when it inhales the gas in the foam it will die quickly. For the animal's welfare it is preferable that the foam itself is inhaled as little as possible. This can be achieved by choosing a suitable bubble size. The larger the bubble, the lower the number of bubbles the animal will inhale and the higher the amount of gas from the bubble that the animal will inhale. Big bubbles tend to burst more easily thus releasing their contents. If desired, the composition of the liquid membrane of the bubble can be chosen to have such a strength that the bubble bursts upon inhaling. The strength depends inter alia on the surfactant(s) used, the concentration thereof, and on known auxiliary agents for making bubbles such as glycerol. A composition resulting in bubbles having a suitable strength can be determined experimentally for the surfactants used, and needs no further elucidation. It is believed that the method is not only suitable for the sanitary slaughter of animals contaminated with a contagious disease, but also for the extermination of rodent pests such as of rats and mice at farms, in granaries and the like. It is not necessary that the animals are already contaminated. Sanitary slaughter can also take place as a precautionary measure, or to create an animal-free area around a contaminated area. An example of a suitable killing gas is nitrogen in a significantly elevated concentration relative to the atmosphere. It is favourable if the gas used for making the foam has a density that is greater than that of air. An increased density is accomplished by a lowered temperature, and by choosing the atomic weight and/or molecular weight of the gas or the various gas components constituting the gas. In case of flammable killing gases (such as carbon monoxide) the likelihood of a fire breaking out is reduced by incorporating the killing gas in the foam. In the scope of the present invention the term “killing gas component” means any gas component whose physiological properties have a killing effect (for example carbon monoxide) or alternatively, simply by diluting or replacing, reduce the oxygen concentration in a gas used to form the foam (including a gas mixture, such as air) such that the death of the animal is accelerated. An example of the latter is for example argon or nitrogen. If an inert (not physiologically active) killing gas component is used, the oxygen concentration is reduced to less than 15% by volume, preferably to less than 12% by volume based on the total gas mixture used to form foam.

Advantageously, the killing gas component is carbon dioxide and is present in the gas at a concentration of at least 60% by volume.

Thus, a foam is provided containing a gas that is sufficiently killing, while the release of gas in the atmosphere does not pose any immediate danger and the risk to the personnel who perform the sanitary slaughter of being exposed to an adverse concentration of the gas, is also reduced.

In order to avoid that the gas halts the respiration of the animal, causing the death to be delayed, it is preferable that in the case where a physiologically active killing gas component is used, some oxygen is present in the gas. In particular, it is preferred that the gas contains oxygen as an auxiliary gas.

The oxygen is present in a concentration that reduces the inhibition of the respiration which occurs in the absence of oxygen. This concentration depends on the particular animal species and the composition of the gas used, and can be determined by means of routine experiments. The use of oxygen as an auxiliary gas is for example advantageous in the case where carbon dioxide is used as a killing gas.

Advantageously, the liquid contains a disinfecting component.

By using this the spreading of a disease can be contained. Also the likelihood of workers transmitting the disease further, which could lead to new contamination niduses, is reduced. Since foam is used, a relatively low amount of disinfecting component can be used which has little negative effect in the case where the animals which are to be sanitarily slaughtered are not incinerated but are left to degrade biologically by rotting.

Advantageously, the disinfecting component is selected from a protease, a ligand or receptor which inhibits bonding of an infectious organism to a host, an antibiotic and an active chlorine compound.

Regarding said ligand or receptor the following is noted. Some micro-organisms, in particular viruses, have to interact in a specific way with the host in order to accomplish an infection, for example penetrate a specific host cell. The liquid could contain a ligand or receptor (including a receptor-fragment, and any molecule having the particular receptor activity, such as for example an antibody) that binds to the micro-organism. Thus, the likelihood of the micro-organism contaminating a host can be reduced. When more than 1 disinfecting component is used their mutual compatibility should be taken into account.

Advantageously, the active chlorine compound is selected from chlorine (Cl₂) and a compound with hypochlorite (OCl⁻) as active ion.

These active chlorine compounds have a broad spectrum of activity, allowing a plurality of organisms to be eliminated. In addition, they are not so toxic that they would cause a waste problem.

A disinfecting effect can also be achieved if the liquid has a pH<3 or >11.

The pH is preferably <2. If one or more disinfecting components are also present, the chosen pH should be compatible with these disinfecting components if one wishes to preserve the disinfecting activity thereof.

A first important embodiment is characterized in that a plurality of animals is sanitarily slaughtered, the said animals being present in a space, and the animals in the space are covered with a layer of foam.

This can be done in a simple manner, for example using a foam gun as is used for example for extinguishing fires. This operating method requires extremely little manpower. The space may be a pasture (such as for ducks and chickens), a tent, into which the animals are driven, or a space in which the animals are kept such as a stable.

In order to facilitate the gathering of the animals, it can be advantageous if, after the animals have been killed, the layer of foam is at least partially broken down by means of a defoamer.

Such agents are known, for example silicone based defoamers.

A second important embodiment is characterized in that the animal is placed in a container which contains a layer of the foam, and the animal is introduced into the layer of foam.

This embodiment is particularly useful for animals kept in cages, such as poultry, wherein the container is moved along the cages and the animals are introduced directly from the cages into the container where, being immersed in the foam, they die quickly.

Advantageously, this embodiment of the method is characterized in that the container has an opening for introducing a bird in the container, said opening having a largest cross section of 15 to 40 cm, and the body of the container having a cross section of at least 50 cm.

This leaves sufficient space for quickly introducing the animals which are to be sanitarily slaughtered into the container, while gas escaped from burst foam bubbles still remains captured in the container. Especially, if the gas or the killing and/or narcotizing gas component(s) thereof have a high molecular weight or atomic weight, it will descend and form a blanket on top of the animals not yet killed, which may contribute to an accelerated death of the animals.

It is preferred that an inner bag is present in the container, and that the foam is inside the inner bag.

The inner bag containing the animals can then be discharged, incinerated or taken to a dumping site, whereas the container is the sturdy part which is handled and which protects the inner bag from becoming damaged. The container is for example a roll container, such as a garbage container, a container for organic matter etc., which is preferably provided with an opening at its top, or alternatively at its sidewall near the top, said opening being barely larger than the animal to be introduced into the inner bag. In the case where it is taken to a dumping site, the inner bag is preferably manufactured out of biodegradable plastic.

The container can also be a bag which is provided with at least 1 loop, where both the bag and loop have such a strength that they do not give way if the bag is filled with animals.

The bag can be lifted at its loop. The bag preferably possesses a side that can be opened, advantageously the underside, through which the inner bag can be removed from the bag. By means of the loop, the bag can for example be lifted above a dumping site or transporting truck, and in accordance with the preferred embodiment wherein the bag is provided with a reclosable opening at its underside, its contents can be discharged via that reclosable opening.

The present invention also relates to a bag suitable for application with the method of the invention, said bag having an opening with a largest cross section of 15-40 cm and the body of the container having a cross section of at least 50 cm, and the bag being provided with at least 1 loop near its top.

The bag may be manufactured from, for example, canvas or from optionally reinforced plastic, and may for example be manufactured using the techniques and materials as are known for plastic bags (called ICBs or Bigbags) for the transport of building materials such as sand.

Advantageously, the bag has a reclosable opening, preferably at its underside, through which its contents can be removed.

A bag according to the invention will now be elucidated with reference to the only FIGURE.

The FIGURE shows a container 1, which contains a bag 2 according to the invention. In the bag 2 an inner bag 3 is provided. In the inner bag a layer of foam A is present (not shown). This foam A is prepared from a surfactant-containing liquid and a gas. The foam A can be prepared by means of a device for blowing bubbles (formation of foam with gas at low pressure) or by means of gas at high pressure and a nozzle (for example a foam gun). The gas comprises a gas component that kills animals, for example carbon dioxide, that acts by displacing oxygen from the body of the animal. The container 1 has wheels for simple movement of the bag 2, for example between rows of cages of poultry which are to be sanitarily slaughtered.

In general, the inner bag 2 will initially contain at least an amount of foam A equal to the void volume ultimately present between the animals stacked in the inner bag 2. At its top bag 2 has a relatively narrow opening 3, through which animals may be introduced in the inner bag 3. The animals fall through the foam A in which they die a quick death. In general, after a sufficient quantity of animals has been collected in the inner bag 3, the inner bag 3 will be sealed together with a major portion of the killing and/or narcotizing gas component of the gas.

At the underside of the bag 2 a sealed, releasable, reclosable large opening 5 is situated, through which an inner bag 3 filled with sanitarily slaughtered animals can be discharged. In order to remove the inner bag 3 from the bag 2, the lid 6 of the mobile container 1 is opened, and the bag 2 is lifted out of the mobile container 1 at loops 7, 7′ in accordance with the embodiment of the method according to the invention described here. The releasable opening 5 is opened above a dumping site or the loading platform of a truck as a result of which the contents of the bag 2 land at the desired place. In order to open the releasable opening 5 a draw-string can be present (not shown). The opening 5 of bag 2 will subsequently be closed again and the bag 2 will be provided with a new inner bag 3 (in arbitrary order). After introducing foam A at a suitable time, the sanitarily slaughtering can be continued. Optionally, it may be decided not to use an inner bag 3.

It is preferred that during filling the opening of at least the inner bag 3 is anchored in an opened state, for example by clamping against lid 6.

1. Method for the sanitary slaughter of an animal, characterized in that at least one body part selected from the nose and the mouth of the animal is covered with a foam prepared from a liquid and a gas, wherein the liquid contains a surfactant, and the gas used for making the foam comprises a gas component having the property to kill and/or narcotize the animal.

2. Method according to claim 1, wherein the killing gas component is carbon dioxide and is present in the gas at a concentration of at least 60% by volume.

3. Method according to claim 1, wherein the gas contains oxygen as an auxiliary gas.

4. Method according to claim 1, wherein the liquid contains a disinfecting component.

5. Method according to claim 4, wherein the disinfecting component is selected from a protease, a ligand or receptor which inhibits binding of an infectious organism to a host, an antibiotic and an active chlorine compound.

6. The method according to claim 1, wherein the liquid contains an active chlorine compound selected from chlorine (Cl₂) and a compound with hypochlorite (ClO⁻) as active ion.

7. The method according to claim 1, wherein the liquid has a pH<3 or >11.

8. The method according to claim 1, characterized in that a plurality of animals is sanitarily slaughtered, the said animals being present in a space, and the animals in the space are covered with a layer of foam.

9. Method according to claim 8, characterized in that, after the animals have been killed, the layer of foam is at least partially broken down by means of a defoamer.

10. Method according to claim 1, characterized in that the animal is placed in a container which contains a layer of the foam, and the animal is introduced into the layer of foam.

11. Method according to claim 10, characterized in that the container has an opening for introducing a bird in the container, said opening having a largest cross section of 15 to 40 cm, and the body of the container having a cross section of at least 50 cm.

12. Method according to claim 10, wherein an inner bag is present in the container, and that the foam is present in the inner bag.

13. Method according to claim 10, wherein the container is a bag provided with at least one loop, said bag and loop having such a strength that they do not give way if the bag is filled with animals.

14. Bag suitable for use with the method according to claim 13, said bag having an opening with a largest cross section of 15-40 cm near its top and the body of the container having a cross section of at least 50 cm, and the bag being provided with at least one loop near its top.

15. Bag according to claim 14, wherein the bag is provided with a reclosable opening at its underside.

16. Method according to claim 13, wherein the bag has an opening with a largest cross section within a range of 15 to 40 cm near a top of the bag, wherein the bag has a body with a cross section of at least 50 cm, and wherein the at least one loop is near the top of the bag.

17. Method according to claim 16, wherein the bag has an underside provided with a reclosable opening.
